(19) United States
(12) Patent Application Publication
(10) Pub. No.: US 2005/0102186 A1
(43) Pub. Date: May 12, 2005

(54) Selection of an item

(76) Inventor: Vicentius Paulus Buil, Eindhoven (NL)

Correspondence Address: Corporate Patent Counsel;Philips Electronics North America Corporation, P O Box 3001, Briarcliff Manor, NY, 10510, US

(21) Appl. No.: 10/478,076

(22) PCT Filed: May 21, 2002
(86) PCT No.: PCT/IB02/01791

(30) Foreign Application Priority Data
May 23, 2001 (EP) 01202019.4

(51) Int. Cl. G06F 17/60

(52) U.S. Cl. 705/26

(57) ABSTRACT

A method for facilitating the selection of at least one item from a selection of items, each of said items comprising identification information identifying the respective item. Said method comprising associating each item with information about at least the last time accessed, providing information about the access frequency of each item, specifying selection criteria relating to the last time accessed and the access frequency, presenting a limited selection of items based on said specified selection criteria.

The present invention relates to a method for facilitating a selection of at least one item from a selection of items, a data structure associated with such an item, a jukebox device comprising a number of such items.

Many consumers have collections of audio recordings at home. Presently such recordings are on a physical media such as vinyl records, compact cassettes, compact discs, etc. Typically such media are stored on shelves, in racks or other storage constructions. The consumer, or user, has various ways of arranging the physical media, eg. By genre, alphabetically by artist or title, by decade such as seventies, eighties, nineties, etc.

However the physical form of the media makes arrangement and rearrangement thereof cumbersome and complicated when the collection grows. Moreover such collections are often shared by several users, eg. members of a household, and these may have different views on which arrangement scheme is to be preferred. If the arrangement scheme is felt to be too complicated for a user the user is compelled to not arrange the media properly after use, but rather to just leave it lying around near the playback device in an unorderly fashion. More complex arrangement schemes, eg. how often a recording was played are almost impossible to maintain. In particular if a preferred recording is just one among others on a recorded media.

With a large collection of music it can be a challenge for the user to decide which music to listen to and select it. Effectively the user has to either rely on his memory of the contents of his music collection or he has to browse through the entire collection in order to find music he wishes to listen to.

A conventional approach to this problem of the arrangement and handling of the physical media in a multiuser environment such as a household is a jukebox. These devices often allow automatic playback of selections by genre, artist, decade or other categorisation, thereby aiding the user in the decision of which music to listen to. The drawback of traditional jukeboxes is that they, primarily because of the physical media they need to store and handle, are too bulky and too slow in operation to be accepted in eg. a living room of a household.

With the advent of compressed digital audio formats, such as MP3 files, and the decreasing prices for harddisks this is changing. Accordingly, various harddisk based jukebox solutions have been presented on the consumer electronics market. An example, incorporated herein by reference is WO-A-99/64969.

Also, quite a lot of jukebox software for the use on personal multimedia computers has been developed. Using such software, some of which may freely be downloaded from the internet, an ordinary multimedia PC may effectively function as a jukebox.

Many of these software applications use the informal ID3 standard, for storing metadata with the music. This standard allows MP3 files to be tagged with information on genre, artist, album title, track title, lyrics, cover picture, and many other types of information. In respect of the above arrangements these data allows for new types of arrangements and categorisations that were not possible beforehand.

In particular the ID3 standard has two frames of interest to the present invention. The first frame is a play counter frame PCTN indicating the number of times an MP3 file has been played. The second frame is a popularity indicator POPM indication how often a specific user has played the MP3 file. For this the user is identified by means of an e-mail address.

In respect of the harddisk based jukeboxes, be it as dedicated units or as general purpose multimedia computers, it should be noted that the harddisk storing the music need not necessarily be local. Rather centrally stored music accessed via a jukebox interface on a personal computer or dedicated unit and received over the internet is readily imaginable.

Despite the improved possibilities for arranging and presenting a selection of music none of the above jukeboxes do however aid the user sufficiently in deciding which music to listen to and selecting it.

It is an object of the present invention to suggest a method, a data structure and a jukebox aiding a user in selecting an item.

According to a first aspect of the invention this object is achieved by a method according to the opening paragraph and comprising the steps of associating each item with information about at least the last time accessed, providing information about the access frequency of each recording, specifying selection criteria relating to the last time accessed and the access frequency, and presenting a limited selection of items based on said specified selection criteria.

This has the effect that the user is presented with a dynamic selection of the music being most preferred by him. The most important criteria for the preference being the freshness and the popularity, ie. the time elapsed since the last time an item was accessed and the overall number of times the item was accessed.

According to a second aspect of the invention this object is achieved by the user of a data structure associated with an item, and comprising at least information about the last time the item was accessed and information from which information about the access frequency of the item may be derived.

This data structure allows for the execution of the method according to the first aspect of the invention.

According to a third aspect of the invention this object is achieved by a jukebox device according to the opening paragraph wherein the input means comprises essentially continuously variable input means for specifying selection criteria relating to the last time accessed and the access frequency.

Thereby an apparatus implementing the method according to the first aspect of the invention and using efficiently the data structure according to the second aspect of the invention is provided.

Advantageous embodiments of the method, the data structure, and the jukebox are found in the respective subclaims.

The invention will now be described in greater detail based on the non-limiting examples of embodiments depicted in the figures. In particular it is emphasised that, though the embodiments relate to musical items, the invention is fully applicable to other audio or video recordings, such as film, music videos, video, still pictures, art, web pages, electronic books, or the like. In these figures

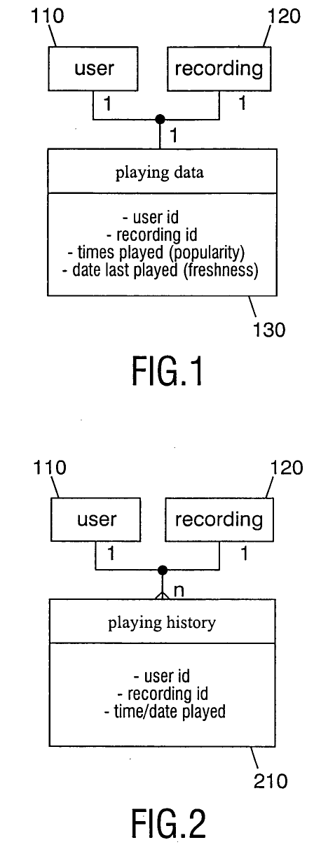

FIG. 1 shows a first example of an information architecture according the present invention,

FIG. 2 shows a second example of an information architecture according the present invention,

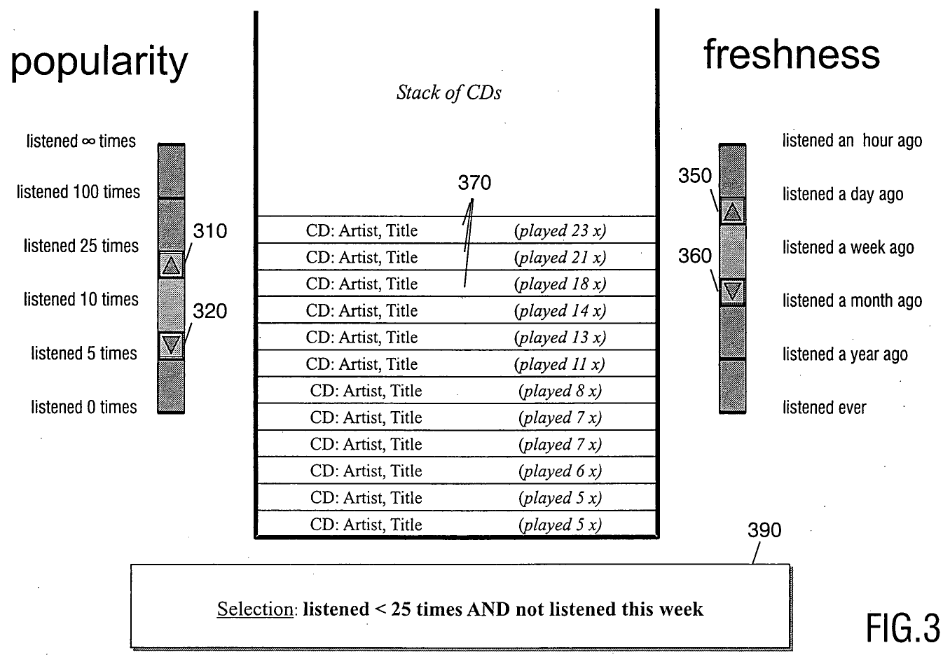

FIG. 3 shows a graphical user interface allowing the selection of a recording based on the preference, and

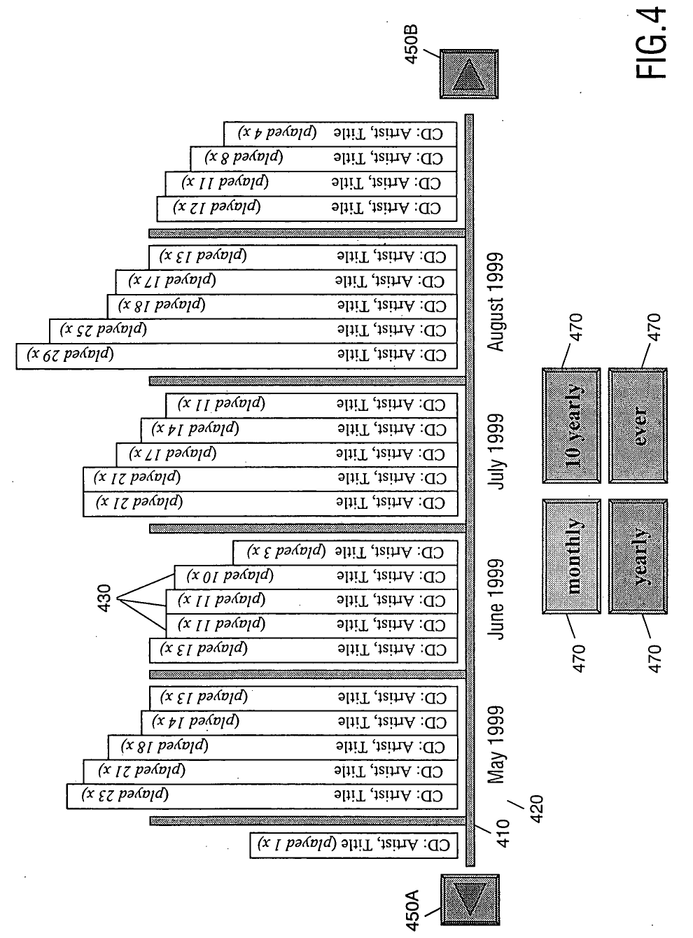

FIG. 4 shows a second graphical user interface for the exploration of a users personal access history,

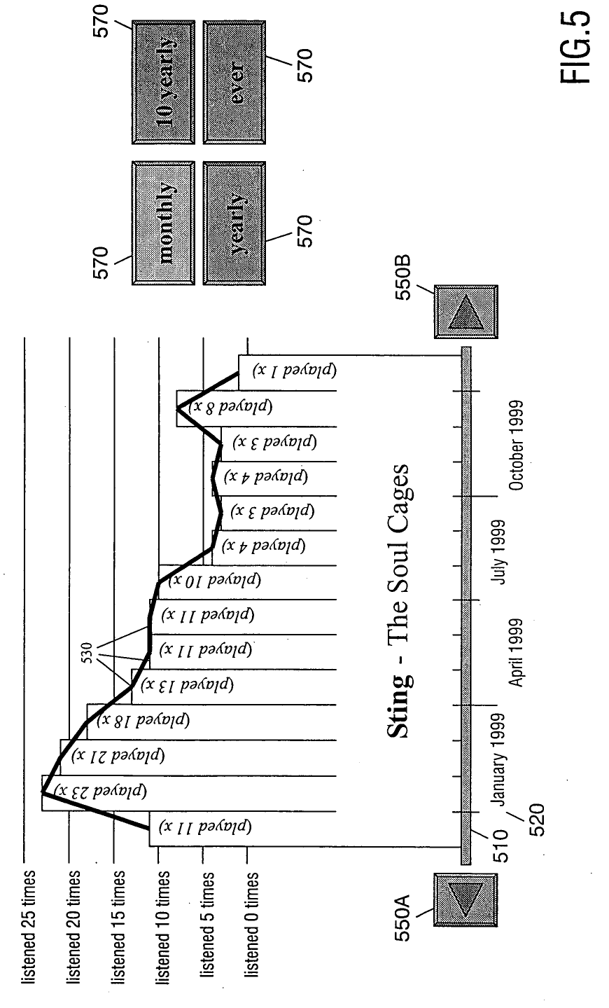

FIG. 5 shows a third graphical user interface depicting the popularity of a single item over time,

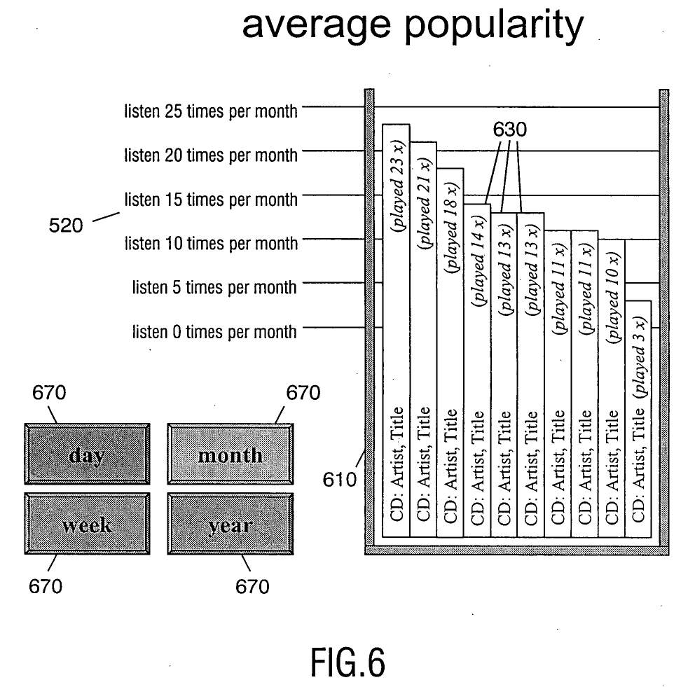

FIG. 6 shows a fourth graphical user interface allowing the assessment of average popularity of a number of items,

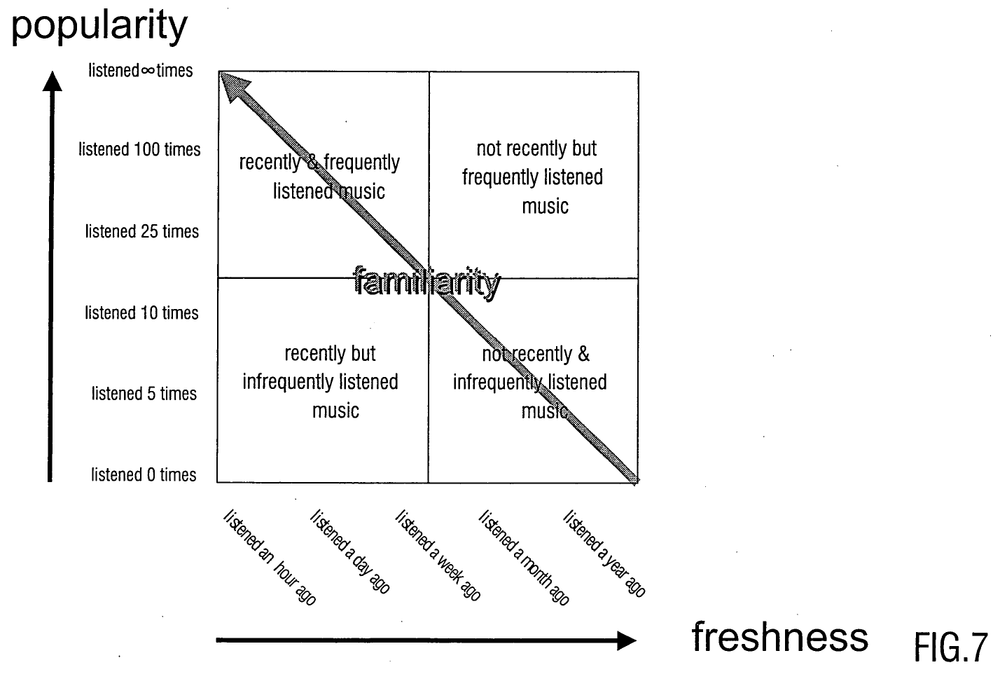

FIG. 7 shows the relation between popularity and freshness, and

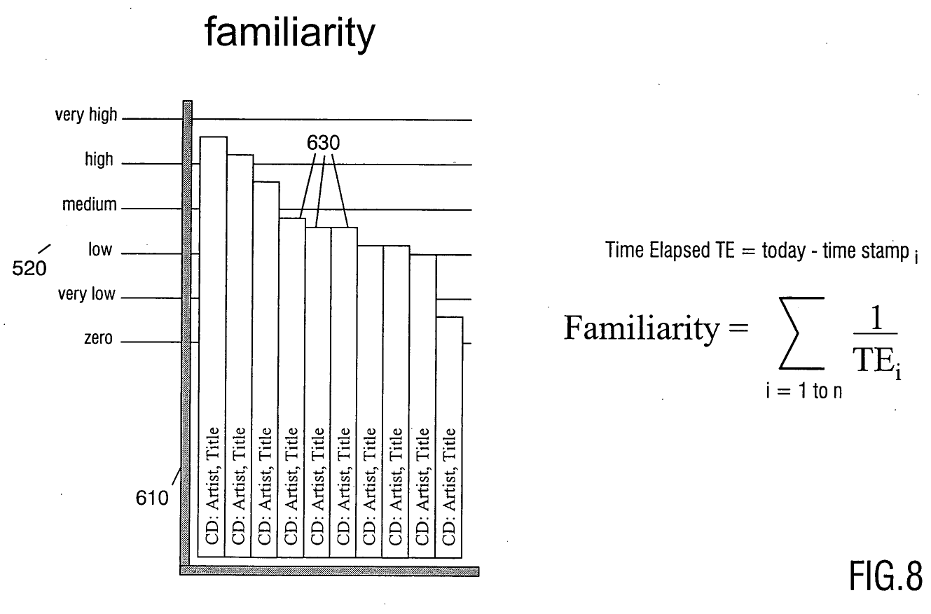

FIG. 8. shows a graphical display of the most familiar items.

Fully implemented the preferred embodiment of invention offers users an improved system comprising method, data structure, and apparatus for selecting an item, such as recorded music items based on how often they have accessed, ie. replayed, when the item is a music item. Every time an item is accessed the system collects information about which item it is, when the item is being accessed, and preferably about who is listening. With this information the system is capable of generating a personal arranged overview of the items, ranging from infrequently accessed to frequently accessed and ranging from recently accessed to never accessed, or any combination thereof.

How frequent and how recent an item was accessed relates to two psychological parameters important in the decision of which music to listen to, viz. “freshness” and “popularity”. Together these two parameters give an indication of how “familiar” the item is to the user at a given time, which in turn is important in estimating how preferred the item is to the user. How these two parameters are related is illustrated in FIG. 7.

The preferred embodiment of present invention suggest a data structure allowing these two parameters to be stored, and subsequently be used in the display of a selection of music preferred by the user, thus allowing a selection of music primarily considered to be preferred by the user.

If the user has just purchased a recorded music item, be it a new record of several recorded items or a single item, he usually does not know the music very well yet. In the data structure 130 of FIG. 1 this would mean that the frame “times accessed” is zero. Preferably the frame “date last accessed” is filled with dummy data always indicating the current date until the item actually has been accessed, upon which the frame contains the date of actual access. In the data structure 210 of FIG. 2 only one frame “time/date accessed” would exist and preferably contain similar dummy data indicating the current date as default. Alternatively a specific NILL value could be used, as it is commonly known in the art of databases.

After accessing the item several times appreciation for the music may grow, especially if it matches the user's taste.

Each of these accessing events will update the contents of the data structures 130 or 210. In the data structure 130 the frame “times accessed” will be incremented each time and the frame “date last accessed” would be updated. In the data structure 210 a new additional entry in the frame “time/date accessed” would be added.

Often the user will grow tired of listening to the new music over and over again, and will revert to listening to older music which generally is not played as frequently as the new music was just after it had been purchased, but has over the total time it has been in the collection been played a great number of times. This music thus has a high value in the frame “times accessed” and a low value in the frame “date last accessed” in the data structure 130 of FIG. 1.

Using both the criteria “freshness” and “popularity” stored in the data structure 130 in combination gives an indication of the “familiarity” of an item to the user. Depending on the mood of the user, his “preference” may be to listen to a familiar music item. This could then either be an item accessed a great number of times and/or accessed recently, or an unfamiliar item, eg. one not accessed very often yet and/or only accessed a long time ago.

The present invention utilises this indication of “preference” for displaying a selection of preferred items based on a user input of respective selection criteria.

FIG. 3 presents a graphical user interface that allows selection of an item on basis of familiarity, defined in terms of freshness and popularity, cf. FIG. 8. The screen exists of four parts, two sliders 310 and 350, a feedback window 390 showing the selection criteria, and the stack horizontal bars representing items of items 370 (CDs) that meet these criteria. With the two sliders the user can form dynamic queries by setting values for popularity and freshness, as demonstrated by B. Shneiderman, Dynamic Queries: Database Searching by Direct Manipulation, CHI proceedings 1992. With slider 310 and one of the buttons 320 or 330 one can set a selection criterion for popularity. Selecting the button 320 results in a range from the slider value, eg. 25, or more times listened to an item (popular items), whereas selecting the button 330 results in a range from the slider value, eg. 25, or less times listened to an item (unpopular items). FIG. 3 shows a situation in which button 330 is selected and thus results in a selection of those albums that the user accessed 25 times or less, as shown in the feedback window 390. With slider 350 one can set a selection criterion for the freshness of an item to the particular user. FIG. 3 shows a situation in which items are selected that are accessed 25 times or less AND not accessed this week. Changing the position of the sliders 310 or 350, or switching the buttons 320 and 330 will result in a dynamic update of the stack of items 370 so that it will meet the new criteria. In the stack, the items are preferably represented by means of aforesaid bars holding at least an identification of the item. As can be seen from FIG. 3 the bar may also hold additional information such as the number of times an item was accessed. The user can pick an item by tapping on the respective bar, for example by means of a touch screen, a mouse, a track ball, a laser pointer on a screen, using voice commands, by using gestures in a virtual reality environment, etc.

Using the data structure of FIG. 2 the possibility of aiding the user in deciding which music to listen to and selecting it is greatly improved. FIG. 4 illustrates such possibilities.

It is well known that some music has a short life cycle, and some music stays forever Oust look at the weekly top 10 and yearly top 100 charts of pop music). The music a person loves to listen to now differs often from the music he loved a few years ago. However, often people have the older music still in our collection, and sometimes it is a nice surprise to hear it again. In this sense, it could be a very nice feature for people if they could explore their own listening history. They could explore music they played often some months, years, or even decades ago and go back to that time period, do new discoveries in old music, or just find out that their music taste has changed.

FIG. 4 presents a user interface that allows for exploration of a personal listening history. The screen presents a rack 410 with groupings of five items 430 (CDs) per time period 420 (months in this case). The items are represented as columns. Though only illustrated for the month of June 1999 all columns comprise an identification of the item. The items in each group of five are the five most popular items in that period. The height of the column depicts the actual popularity of the CD in that period. The column may, as illustrated be provided with text corresponding to the height of the columns. For example, the first CD in the group of June 1999 was accessed 13 times in June 1999. With the buttons 450A and 450B the user can scroll further to the past and back. With the buttons 470 the user can select the resolution of the time scale, from months to years, decades or no time scale (ever). The user can pick an item by tapping on the respective column, for example by means of a touch screen, a mouse, a track ball, a laser pointer on a screen, using voice commands, by using gestures in a virtual reality environment, etc. By selecting no time scale (ever) the most popular items ever (for as long as the system is used) will be displayed. As such the most popular item will be shown to the left, followed by the next most popular item, and so on. It should further be noted that the number of different items displayed within each time interval, is just a matter of selection, hence it could be five as displayed in FIG. 4 but it could just as well be ten as displayed in FIG. 6. The number used could be selectable by the user or automatically adapted in accordance with the size of the display.

The data structure of FIG. 2 also allows for different user interfaces. In FIG. 5 is illustrated a user interface where the number of accesses are presented for a single specific item. For the specific item, the number of accesses are calculated for specific time intervals, selected by the user. The display may use columns 530, but may also just use an approximated curve, as there is only one item, which may be selected. Using the buttons 570 the user may specify a desired time interval, such as month, year, 10 years or even ever. The latter, simply being one column representing the total number of times the item was ever accessed. Also, here the display may have scroll buttons 550A, 550B, allowing the user to look at the present or the past.

Using the data structure of FIG. 2 it is also possible to calculate the relative popularity of the items in the users collection. That is to say in the calculation the time the item was owned is taken into account. The relative popularity for an item is then calculated as

$$Relative {Popularity}_{i} = {Popularity}_{i} \frac{TimeUnit}{{Lifetime}_{i}}$$

The lifetime is the time an item is owned and could eg. be calculated based on the date of first access stored in the data structure of FIG. 2. The time unit is selected by the user. Thus an item owned for 20 years and accessed 100 times, will get a relative popularity of 5 accesses/year whereas an item owned only a month and played 5 times would get a (projected) relative popularity of 60 accesses/year. Per month these numbers for relative popularity would be 0.42 and 5 respectively. One could also decide to not let the relative popularity exceed the absolute popularity, in which the relative popularity numbers in the example per year would both be 5. This avoids misleading the user with projected numbers.

In FIG. 6 this relative average popularity has been used in another user interface. The ten different items which on average have been accessed most frequently since the system was initialised are displayed as columns. The height of the column indicates the popularity per the time unit in conjunction with the scale 520, in this case 13 and 14 times per month in average for the items 630, respectively. The buttons 670 alter the time unit and thus the scale 520 in conjunction to which the items are presented. The items can be selected by tapping on the respective columns. In order to identify the items the columns are preferably provided with identifying text, as shown for the items 630. As shown, the display could be provided with a scroll button 650 allowing the user to scroll the display to see selections with a lower average popularity.

As mentioned earlier FIG. 8 relates to the familiarity of the items. Using the data structure of FIG. 2, the familiarity may be calculated as

$$Familiarity = {\sum }_{i = 1 to n} 1 / {TE}_{i}$$

where TEᵢ is the elapsed time since the i'th access, given by:

$${TE}_{i} = today - time {stamp}_{i} \qquad 10$$

This information may be used to generate a display as shown in FIG. 8. In FIG. 8, the height of the columns represent the familiarity of the ten items most familiar to the user, as calculated using the above formula. As shown, this display may also have the possibility to scroll through less familiar items. Eg. by means of scroll buttons 850 of which only one is shown, because the left-most column is the item with the overall highest familiarity.

As can be seen from the above description of various displays, the data structures according to the invention allows that the user does not have to rely on his memory of the contents of his music collection or browse through the entire collection in order to find music he wishes to listen to.

As mentioned earlier an audio collection is often used by more than one person in the home, and the popularity and especially the freshness of an item are strict personal parameters of an item, some means for identification must be provided. Accordingly, in that case, both of the user interfaces described above require the administration of an entity 110 called “user”. As For this identification one could rely on techniques like RF ID technology, fingerprint recognition, facial recognition, speaker identification, or any other identification technique.

Besides the entity “user” 110, also some unique item identification 120 is needed. For audio recordings, such as music the identification could eg. be the ISRC code administered by the International Federation of Phonographic Industry. For combinations of users and recordings data is gathered on freshness and popularity during playback of recordings.

From here on the required detail in the user interface determines what access data has to be collected. In case of the user interface depicted in FIG. 3, which only supports selection on overall for gathering of cumulative data only, i.e. for every user and item there is one database record (in the entity 130 “access data”) which contains the total times accessed and a timestamp of the most recent access event.

To allow the presentation of an actual access history (showing for example the actual albums someone played three weeks ago, as in the user interface depicted in FIG. 4) one needs a data model as shown in FIG. 2. In contrast with FIG. 1, every access event is administered with a timestamp (in the entity 210 “access history”), i.e. for every user-item combination there are as many database records as the times the particular user played the particular item. From these data one can calculate cumulative data for the freshness and popularity of an item for different time periods.

As already mentioned the present invention, though described in the context of audio recordings, may also be utilised for video recordings or combined audiovisual recordings, such as music videos, still pictures, art, or the like.

Furthermore the invention could be used for assessing the popularity of web pages visited. In that way an automatically generated overview of the 10 most popular web pages in a give time period could be given, sorted by frequency of visiting, by how recently visited, or a combination of these. Also, with the data structure of the invention presentations as depicted in FIGS. 3, 4, 5, 6 and 8 are possible on these data. These kinds of features could typically be part of a standard web browser.

The invention could also be applied to library systems, so as to assess the popularity of books in the collection looking at the times and frequency they have been loaned, possibly over certain time periods. In particular, these libraries could be electronic libraries of e-books in the home, where presentations like FIG. 3 and FIG. 4 make sense for personal selections. This could be especially useful for children's books, as they are read again and again. Electronic libraries would typically use E-books such as those widely available to day, e.g. as provided by Glassbook Inc., Librius Inc., NuvoMedia Inc. and SoftBook Press Inc.

Another field of use could be electronic game collections, be it in the context of personal collections or in rental stores. When media become larger and larger, PlayStation and Nintendo games may be combined on a single recording media. If in this case the invention is implemented in the game console quick and easy access to the games stored on a single media would be possible. In a similar fashion the invention could be applied on PCs in the home having multiple games stored on them. All these environments could benefit from presentations according to the invention as presented in FIGS. 3, 4, 5, 6 and 8.

As can be seen the data structures may be used with a large variety of media. The way in which the data structure is stored depends on the actual media to which it is associated. If the data structure of FIG. 1 is used, the data about the frequency of use, personalized or not, can be stored with the item itself. This is, of course, provided that the item is stored on a rewriteable media such as a hard disk, solid state RAM, rewriteable CD or DVD, a jukebox containing these or a combination thereof, or the like. This is eg. the case if the files are MP3 audio files with ID3 tags. This is however not very practical for very large user groups, because it requires quite a lot of information to be stored with each item. In this case it is more appropriate to store the data structure as usage profiles separately, either on the same medium, or on a separate medium. The latter will evidently be necessary if the item is itself stored on a read only media such as a CD, a DVD, or if the items are stores in connection with a remote server not allowing the user to write on it. As an example a CD jukebox system could be equipped with separate storage means such as a hard disk or a solid state memory. This would allow the storing of frequency, ie. times accessed, and last time accessed, as needed with the data structure of FIG. 1 or of individual time stamps as needed with the data structure of FIG. 2, possibly together with the unique IRSC code CD identifier.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word ‘comprising’ does not exclude the presence of other elements or steps than those listed in a claim. The invention can be implemented by means of hardware comprising several distinct elements, and by means of a suitably programmed computer. In a device claim enumerating several means, several of these means can be embodied by one and the same item of hardware. The mere fact that certain measures are recited in mutually different dependent claims does not indicate that a combination of these measures cannot be used to advantage.

1. A method for facilitating a selection of at least one item from a selection of items, each of said items comprising identification information identifying the respective item, characterized in that the method comprises:
associating each item with information about at least a last time accessed,
providing information about an access frequency of each item,
specifying selection criteria relating to the last time accessed and the access frequency, and
presenting a limited selection of items based on said specified selection criteria.

2. A method according to claim 1, characterized in that the information relating to the access frequency is for a given time period.

3. A method according to claim 2, characterized in associating each item with information about each time it was accessed, and calculating the access frequency of each item on the basis of the given time period and the information about each time the item was accessed.

4. A method according to claim 2, characterized in associating each item with information about the number of times it was accessed and calculating the access frequency of each item on the basis of the given time period and the information about each time the item was accessed.

5. A method according to claim 1, characterized in that the information associated with each item about at least the last time accessed, and the information provided about the access frequency of each item is further associated with information about a specific user, and that the specified selection criteria further includes an identification of that user.

6. Method according to claim 1, characterized in that the selection criteria relating to the last time accessed and the access frequency are specified by means of an essentially continuously variable input means.

7. Data structure associated with an item, characterized in comprising at least information about the last time the item was accessed and information from which information about the access frequency of the item may be derived.

8. Data structure according to claim 7, characterized in that the information from which information about the access frequency of the item may be derived comprises information about each time the item was accessed.

9. Data structure according to claim 7, characterized in that the information from which information about the access frequency of the item may be derived comprises a counter.

10. Data structure according to claim 7, characterized in further comprising identification information for at least one user and, for that specific user, information about the last time the item was accessed and information from which information about the access frequency of the item may be derived.

11. Data structure according to any one of claims 9, characterized in that the data structure comprises the item.

12. Jukebox device comprising a memory for storing a number items, a display for displaying identification information identifying said items, input means for selecting at least one of said items, and output means for accessing an item selected among said items, characterized in that said input means comprises essentially continuously variable input means for specifying selection criteria relating to a last time accessed and an access frequency.

13. Jukebox device according to claim 12, characterised in that it comprises a multimedia computer and on which items having an associated data structure has been stored.

14. A storage medium on which a data structure as claimed in claim 7 has been stored.

15. A device for facilitating a selection of at least one item from a selection of items, each of said items comprising identification information identifying the respective item, characterized in that the device comprises:
means for associating each item with information about at least a last time accessed,
means for providing information about an access frequency of each item,
means for specifying selection criteria relating to the last time accessed and the access frequency, and
means for presenting a limited selection of items based on said specified selection criteria.
